(19) United States
(12) Patent Application Publication
(10) Pub. No.: US 2026/0080203 A1
(43) Pub. Date: Mar. 19, 2026

(54) DUAL FREQUENCY RADIO-FREQUENCY IDENTIFICATION DEVICE

(71) Applicant: TROVAN LIMITED, Douglas (IM)

(72) Inventors: Frederic SACKSTEDER, Bruebach (FR); José Luis GEIJO, Marin-Epagnier (CH)

(21) Appl. No.: 18/884,194

(22) Filed: Sep. 13, 2024

(51) Int. Cl. G06K 19/07; G06K 7/10; G06K 19/077

(52) U.S. Cl. CPC G06K 19/0724; G06K 7/10366; G06K 19/07767; G06K 19/07773

(57) ABSTRACT

Techniques are described to provide improved connectivity for low frequency (LF) and high frequency (HF) radio-frequency identification (RFID) applications. In particular, a dual frequency RFID device is configured with two interfaces that communicate at different frequencies and which includes a shared memory, at least part of which can be accessed through both of the two interfaces. As such, existing LF RFID readers can communicate with the dual frequency RFID device via one interface, and HF RFID readers can communicate with the RFID device via the other interface. In some implementations, the same data in the shared memory can be accessed through either interface, allowing the same dual frequency RFID device to be accessed irrespective of whether the RFID reader is a LF RFID reader or a HF RFID reader.

### FIELD OF THE DISCLOSURE

The present disclosure relates to Radio Frequency Identification (RFID) applications, and more particularly, to an RFID system that utilizes a combination low frequency (LF) and high frequency (HF) tag.

### SUMMARY OF THE DISCLOSURE

Radio-frequency identification (RFID) devices use electromagnetic fields to communicate with one another via antennas. Typically, one RFID device operates as a reader, and another RFID device is an RFID tag. The RFID reader can access data stored by the RFID tag by receiving data transmitted from the RFID tag's antenna to the RFID reader's antenna. An RFID tag is often implemented as a small device that can be attached to an object, and which can be scanned by RFID readers to track or otherwise identify the object.

Accordingly, techniques are described herein to provide improved connectivity for LF and high frequency HF RFID applications. In particular, a dual frequency RFID device is configured with two interfaces that communicate at different frequencies and which includes a shared memory, at least part of which can be accessed through both of the two interfaces. As such, existing LF RFID readers can communicate with the dual frequency RFID device via one interface, and HF RFID readers can communicate with the RFID device via the other interface. In at least some implementations, the same data in the shared memory can be accessed through either interface, allowing the same dual frequency RFID device to be accessed irrespective of whether the RFID reader is a LF RFID reader or a HF RFID reader. This allows, among other benefits, connectivity to the cloud from the dual-frequency RFID device while also allowing LF RFID readers to access the same stored data.

According to some aspects of the instant disclosure, the techniques described herein relate to a device including: a first antenna configured to receive and transmit (e.g., communicate) at a first frequency; a second antenna configured to receive and transmit (e.g., communicate) at second frequency, different from the first frequency; a non-transitory computer readable storage medium storing first data; and a controller coupled to the first antenna and to the second antenna and configured to: transmit the first data stored in the non-transitory computer readable storage medium via the first antenna at the first frequency; and transmit the first data stored in the non-transitory computer readable storage medium via the second antenna at the second frequency.

According to some aspects of the instant disclosure, the techniques described herein relate to a system including: a passive radio-frequency identification (RFID) tag including: a first antenna configured to transmit at a first frequency; a second antenna configured to transmit at second frequency, different from the first frequency; a non-transitory computer readable storage medium storing first data; and a controller coupled to the first antenna and to the second antenna and configured to: transmit the first data stored in the non-transitory computer readable storage medium via the first antenna at the first frequency; and transmit the first data stored in the non-transitory computer readable storage medium via the second antenna at the second frequency; a first RFID reader configured to communicate with the first antenna of the RFID tag at the first frequency and thereby receive the first data stored in the non-transitory computer readable storage medium; and a second RFID reader configured to communicate with the second antenna of the RFID tag at the second frequency and thereby receive the first data stored in the non-transitory computer readable storage medium.

According to some aspects of the instant disclosure, the techniques described herein relate to a method including: transmitting, by a controller, first data to a first radio-frequency identification (RFID) reader at a first communication frequency via a first antenna, wherein the first data is stored in a non-transitory computer readable storage medium; and transmitting, by the controller, the first data stored in the non-transitory computer readable storage medium to a second RFID reader at a second communication frequency, different from the first frequency, via a second antenna.

According to some aspects of the instant disclosure, the techniques described herein relate to a method including: winding a first plurality of conductive turns to form a first antenna; winding a second plurality of conductive turns to form a second antenna; arranging an integrated circuit including a controller and a non-transitory computer readable storage medium between the first antenna and second antenna; and galvanically connecting the integrated circuit to the first antenna and to the second antenna.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic of a system comprising a dual frequency RFID device, according to some embodiments of the present disclosure;

FIG. 2 is a cross-sectional view of an illustrative dual frequency RFID device, according to some embodiments of the present disclosure;

FIG. 3 is a flowchart of a method of operating a dual frequency RFID device, according to some embodiments of the present disclosure;

FIGS. 4A-4D depict a process of fabricating a dual frequency RFID device, according to some embodiment of the present disclosures; and

FIGS. 5A-5C depict a process of fabricating a dual frequency RFID device, according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

Certain embodiments and principles will be discussed in more detail with reference to the figures.

As described above, RFID tags are devices that can be scanned by an RFID reader through radio communication between antennas present in each device. Various types of RFID devices operate within different frequency bands, which include devices that operate in a low frequency (LF) band (100 kHz-150 kHz), and at a high frequency (HF) of 13.56 MHz. Devices including smart cards and portable devices such as smart phones are typically configured to communicate at the 13.56 MHz frequency, and often do so in conjunction with the near field communication (NFC) protocol.

LF RFID devices are often employed in environments where higher frequencies would be blocked by materials like metal or water. Within the roughly 100 kHz-150 kHz communication frequencies, transmissions are relatively unaffected by interference and by intervening materials, unlike higher frequency radio signals. Typical LF RFID applications include tracking of livestock, tracking of inventory, access control, and pharmaceutical tracking. For example, LF RFID tags are often implanted into animals to track them for industrial or veterinary uses.

In contrast, HF RFID devices, including NFC devices, are often implemented in communication devices such as smart phones, as well as other objects such as passports and smart cards. Since HF RFID is often implemented in devices that have connectivity to the cloud, data obtained by a HF RFID reader can be easily transmitted elsewhere and used in IoT (Internet of Things) applications.

Accordingly, as discussed herein, the disclosed systems and methods provide novel techniques for improved connectivity for both LF and HF RFID applications. In particular, a dual frequency RFID device is configured with two interfaces that communicate at different frequencies and which includes a shared memory, at least part of which can be accessed through both of the two interfaces. As such, existing LF RFID readers can communicate with the dual frequency RFID device via one interface, and HF RFID readers can communicate with the RFID device via the other interface. In at least some implementations, the same data in the shared memory can be accessed through either interface, allowing the same dual frequency RFID device to be accessed irrespective of whether the RFID reader is a LF RFID reader or a HF RFID reader. This allows, among other things, connectivity to the cloud from the dual-frequency RFID device while also allowing LF RFID readers to access the same stored data.

As one non-limiting illustrative example, a dual frequency RFID device may be attached to an object used for industrial tracking (e.g., a crate). Within an industrial facility it may not be feasible to scan this device with a HF RFID reader due to high frequency radio waves being blocked or otherwise attenuated (e.g., by metal walls or other structures) within the facility. The dual frequency RFID device may, however, be scanned with a LF RFID reader inside this facility since, as described above, the frequencies on which it operates are relatively unaffected by such interference. Subsequently, the object may be transferred outside the facility, where HF RFID scanning of the object may be preferable due to cloud connectivity of the HF RFID reader. In some cases, the HF RFID reader may read the same data that was read inside the facility by the LF RFID reader, since both interfaces have access to the same shared memory.

Accordingly, in some embodiments of the instant disclosure, the disclosed systems and methods enable RFID tags to be read/scanned by modern and/or legacy readers, for which the scanned information can be communicated over a network to, but not limited to, a cloud, another device, a third party platform, portal, account, and the like, or some combination thereof. Thus, as provided via the novel functionality effectuated via the combination antenna-type RFID tag, discussed herein, enhanced access to RFID data and associated real-world assets can be realized, as a “second life” can be given to legacy systems, while modern systems can continue to operate without a reduction in capacity, efficiency and/or resource utilization.

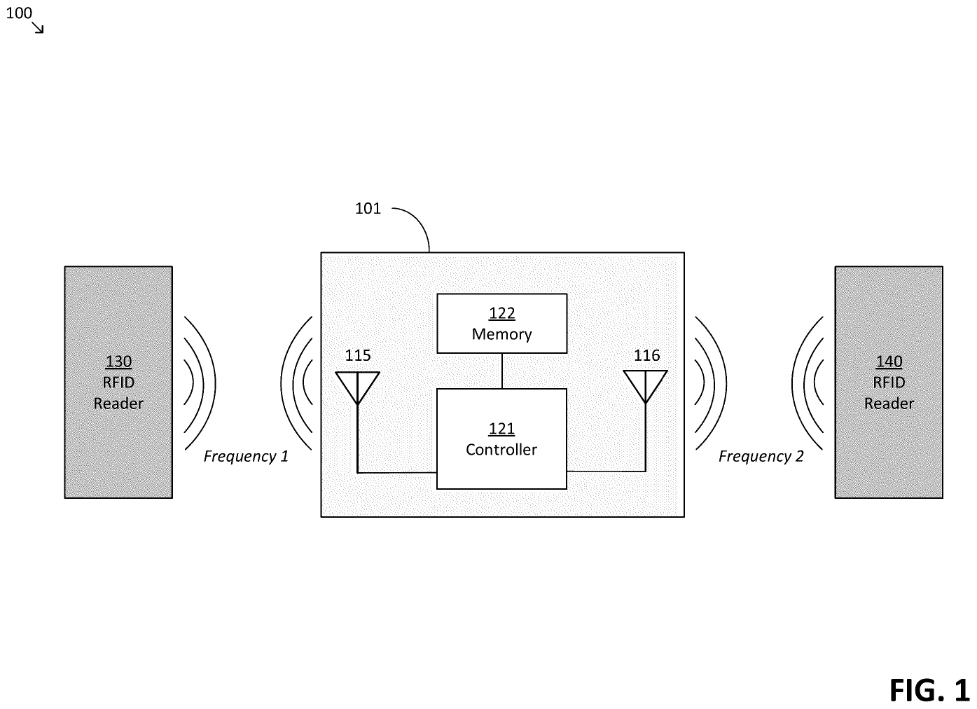

FIG. 1 is a schematic of a system comprising a dual frequency RFID device, according to some embodiments. System 100 includes a dual frequency RFID device 101, which is capable of communication with RFID readers 130 and 140 via different frequencies. Communication between the dual frequency RFID device 101 and the RFID reader 130 is provided via antenna 115, which is configured to transmit and/or receive at a first frequency (“Frequency 1” in FIG. 1). Similarly, communication between the dual frequency RFID device 101 and the RFID reader 140 is provided via antenna 116, which is configured to transmit and/or receive at a second frequency (“Frequency 2” in FIG. 1). The dual frequency RFID device includes a controller 121, coupled to a memory 122, which is configured to control communication through antennas 115 and 116, and thereby provide access to the memory 122 by either RFID reader 130 or 140.

According to some embodiments, the dual frequency RFID device 101 may be a passive device. That is, the dual frequency RFID device may not include a battery or other internal power source. Instead, the energy for the device 101 to communicate with RFID reader 130 and/or 140 via antenna 115 and/or 116, respectively, may be provided inductively from the respective RFID reader. According to some embodiments, the dual frequency RFID device 101 may be an active device and include a battery or other power source (not shown in FIG. 1).

In the example of FIG. 1, antennas 115 and 116 may be implemented as any suitable type of antenna, such as but not limited to a coil (with or without a core material), a linear antenna, a circular antenna, a patch antenna, dipole antenna, or a near-field antenna. In some embodiments, the antennas 115 and 116 may be implemented as different types of antennas.

In some embodiments, antenna 115 is configured to communicate at a frequency that is greater than or equal to 50 kHz, 75 kHz, 100 kHz, 125 kHz, 130 kHz, 135 kHz, 140 kHz, or 145 kHz. In some embodiments, antenna 115 is configured to communicate at a frequency that is less than or equal to 150 kHz, 145 kHz, 140 kHz, 135 kHz, 130 kHz, 125 kHz, 100 kHz, or 75 kHz. Any suitable combinations of the above-referenced ranges are also possible (e.g., antenna 115 is configured to communicate at a frequency that is greater than or equal to 130 kHz and less than or equal to 140 kHz, etc.).

In some embodiments, antenna 116 is configured to communicate at a frequency that is greater than or equal to 13.52 MHz, 13.53 MHz, 13.54 MHz, 13.55 MHz, 13.56 MHz, or 13.57 MHz. In some embodiments, antenna 116 is configured to communicate at a frequency that is less than or equal to 13.58 MHz, 13.57 MHz, 13.56 MHz, 13.55 MHz, 13.54 MHz, or 13.53 MHz. Any suitable combinations of the above-referenced ranges are also possible (e.g., antenna 116 is configured to communicate at a frequency that is greater than or equal to 13.55 MHz and less than or equal to 13.57 MHz, etc.). It may be appreciated that an antenna communicating using the 13.56 MHz standard may not always be configured to receive or transmit at precisely 13.56 MHz, and/or during operation the frequency may vary due to frequency modulation of a signal. As such, an antenna communicating using the 13.56 MHz standard may more generally be configured to communicate at a frequency within the above ranges.

According to some embodiments, the winding directions of the antennas 115 and 116 may be arranged to avoid parasitic injections from one of the antennas during its operation into the other antenna. For instance, the winding directions of the antennas 115 and 116 may be arranged so that the antenna 115 is wound in the opposite direction to antenna 116.

In the example of FIG. 1, controller 121 is configured to process signals received by either of antennas 115 and 116, and to control either or both of antennas 115 and 116 to transmit information at their respective frequencies. The controller 121 may be configured to transmit via either antenna by controlling the antenna to produce, for instance, frequency modulated and/or amplitude modulated analog signals, and/or via digitally modulated digital signals (e.g., amplitude-shift keying or frequency-shift keying). Any such types of signals may also be received by either antenna and decoded (e.g., through demodulation) by the controller 121.

In the example of FIG. 1, controller 121 is configured to respond to requests to read particular data from the memory 122 (e.g., an identification code) as conveyed by, and decoded from, a signal received by either antenna 115 or 116. In some embodiments, controller 121 is configured to receive and decode, and to generate and transmit, signals according to the near field communication (NFC) standard.

According to some embodiments, controller 121 is configured to operate antenna 115 to detect the presence of an electromagnetic field at the first frequency, and in response to disable (e.g., ignore signals from, disable, and the like) antenna 116. Disabling antenna 116 in this situation may avoid antenna 116 from injecting parasitic energy or otherwise corrupting a signal received by antenna 115. For example, information may be added to the parity bits, information bits and/or header which can signal the “ignore” and/or “disable” operation, such that antenna 116 may be configured as “passive.” Similarly, according to some embodiments, controller 121 is configured to operate antenna 116 to detect the presence of an electromagnetic field at the second frequency, and in response to disable antenna 115. According to some embodiments, when controller 121 detects the presence of an electromagnetic field at the first frequency and the presence of an electromagnetic field at the second frequency, the antenna with the higher operational frequency is disabled to favor operation of the lower power antenna.

The combination of controller 121 and memory 122 may be implemented in numerous ways, including as an integrated circuit (IC) that comprises both controller 121 and memory 122, as an integrated circuit that comprises controller 121 and a separate coupled memory, in custom circuitry (e.g., an ASIC), or as semi-custom circuitry resulting from configuring a programmable logic device. According to some embodiments, dual frequency RFID device 101 comprises an integrated circuit comprising controller 121 and memory 122, which is arranged on a single die. Controller 121 may be implemented as fixed logic, or as programmable logic, or as a combination of fixed and programmable logic.

According to some embodiments, memory 122 may be implemented as, or may include, one or more of types of non-volatile memory, including but not limited to: random access memory (RAM), read only memory (ROM), Erasable Programmable ROM (EPROM), Electrically Erasable Programmable ROM (EEPROM), eFuse memory, ferroelectric RAM, or combinations thereof, as discussed above.

In some embodiments, memory 122 is a non-volatile memory that stores a comparatively small amount of information, such as less than 512 bits, or less than 256 bits. Additionally, or alternatively, memory 122 may store values to be accessed by the respective RFID readers 130 and 140. For instance, memory 122 may store a plurality of bits relating to a LF RFID reader (e.g., legacy LF RFID code) and a plurality of bits relating to a HF RFID reader (e.g., a code complying with the NFC ISO standard).

According to some embodiments, the antenna 115 and the antenna 116 may each be galvanically connected to the controller 121, either directly or indirectly via one or more other components. Each antenna may be, for instance, soldered directly to the controller 121, or connected to the controller via a printed circuit board (PCB). In some cases, the controller, memory and antennas 115 and 116 may be formed on a common interposer (e.g., a die including the controller and memory may be coupled to each antenna through the interposer), or implemented as a system on a chip (SoC).

In the example of FIG. 1, the RFID reader 140 may include any one or more of: a smart phone, a smart watch, a kiosk, a retail payment device.

In some embodiments, the dual frequency RFID device 101 may comprise one or more substrates on which any one or more of antenna 115, antenna 116, controller 121 and memory 122 may be arranged.

According to some embodiments, the dual frequency RFID device 101 may be arranged within a suitable housing that includes the antennas 115 and 116, the controller 121 and the memory 122. For instance, the housing may be a capsule comprising, or formed from, glass or some other dielectric.

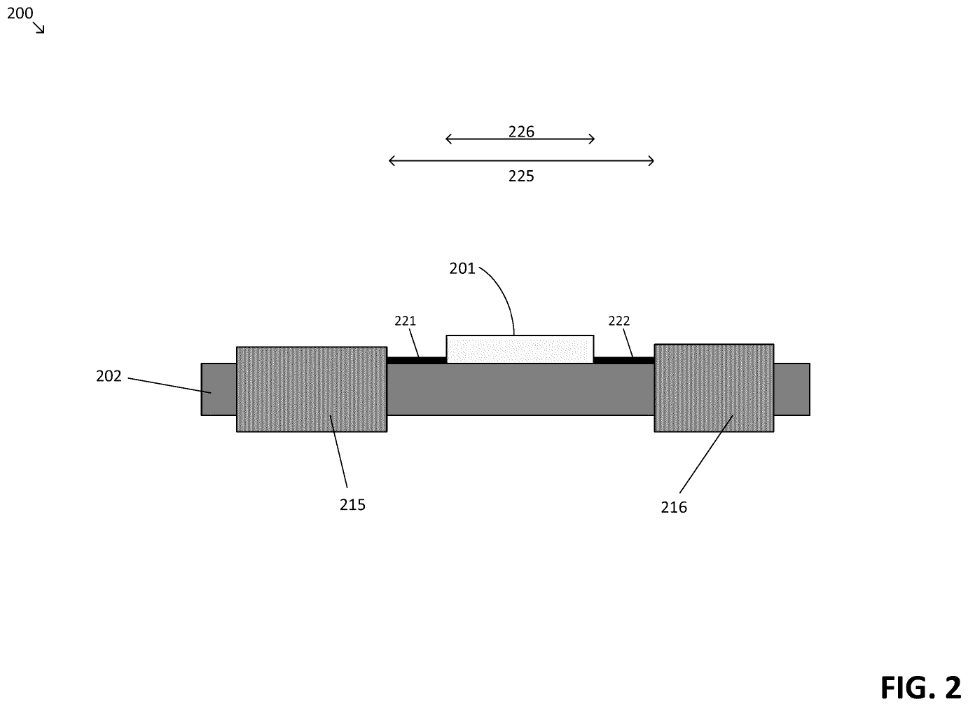

FIG. 2 is a cross-sectional view of an illustrative dual frequency RFID device, according to some embodiments. Dual frequency RFID device 200 is an example of one implementation of a dual frequency RFID device 101 as described above. In the example of FIG. 2, the dual frequency RFID device 200 comprises a core 202 around which an antenna 215 is formed from a plurality of windings of a conductive material and around which an antenna 216 is formed from a plurality of windings of a conductive material. An integrated circuit 201 comprising a controller and memory (e.g., controller 121 and memory 122) is arranged on top of the core 202. The integrated circuit 201 is coupled to the antennas 215 and 216 via connections 221 and 222, respectively.

According to some embodiments, the integrated circuit 201 may be implemented as a single die, as described above. The integrated circuit 201 may comprise a memory implemented as any one or more of the types of memory described above in relation to memory 122. According to some embodiments, the integrated circuit may be arranged directly on the core 202 (e.g., without an intervening printed circuit board).

In the example of FIG. 2, core 202 may be formed from, or may comprise, any suitable material having magnetic permeability, including steel, iron, amorphous metals, ferrite, or combinations thereof. A ferrite core may be particularly desirable given ferrite's high magnetic permeability, low electrical conductivity and low losses. According to some embodiments, core 202 may be provided as a cylindrical rod or a long cuboid, either of which would have a cross-sectional view as depicted in FIG. 2.

In some embodiments, core 202 has a length that is greater than or equal to 1 mm, 5 mm, 10 mm, 25 mm, 50 mm, 75 mm, or 100 mm. In some embodiments, core 202 has a length that is less than or equal to 150 mm, 100 mm, 75 mm, 50 mm, 25 mm, 10 mm, or 5 mm. Any suitable combinations of the above-referenced ranges are also possible (e.g., core 202 has a length that is greater than or equal to 25 mm and less than or equal to 100 mm, etc.).

In some embodiments, core 202 has a width (e.g., the diameter of a cylindrical core, or a width along a side of a cuboid-shaped core) that is greater than or equal to 0.5 mm, 1 mm, 1.5 mm, 2 mm, 2.5 mm, 3 mm, 3.5 mm, 4 mm, 4.5 mm or 5 mm. In some embodiments, core 202 has a width that is less than or equal to 10 mm, 5 mm, 4.5 mm, 4 mm, 3.5 mm, 3 mm, 2.5 mm, 2 mm, 1.5 mm, or 1 mm. Any suitable combinations of the above-referenced ranges are also possible (e.g., core 202 has a width that is greater than or equal to 3 mm and less than or equal to 5 mm, etc.).

In the example of FIG. 2, the antennas 215 and 216 are each formed from a plurality of windings of a conductive material. Each antenna may be formed from the same, or different, conductive materials. In some embodiments, the antenna 215 and/or the antenna 216 is formed from, or comprises, copper. For instance, the antenna 215 and/or antenna 216 may be formed from a plurality of windings of a copper wire.

According to some embodiments, the conductive material from which the windings of antenna 215 and/or antenna 216 are formed is provided as a wire. In some embodiments, the diameter of such a wire may be greater than or equal to 5 μm, 10 μm, 15 μm, 20 μm, 25 μm, 30 μm, 35 μm, 40 μm, 45 μm, 50 μm, 60 μm, 65 μm, 70 μm, or 75 μm. In some embodiments, the diameter of such a wire may be less than or equal to 80 μm, 75 μm, 70 μm, 65 μm, 60 μm, 55 μm, 50 μm, 45 μm, 40 μm, 35 μm, 30 μm, 25 μm, 20 μm, 15 μm, or 10 μm. Any suitable combinations of the above-referenced ranges are also possible (e.g., the wire has a diameter that is greater than or equal to 10 μm and less than or equal to 15 μm, or the wire has a diameter that is greater than or equal to 60 μm and less than or equal to 65 μm, etc.). In some embodiments, the antenna 215 may be formed from a wire with a different diameter to the wire from which antenna 216 is formed. For instance, antenna 215 may be a low frequency antenna formed from a wire having a diameter greater than or equal to 10 μm and less than or equal to 15 μm, whereas antenna 216 may be a high frequency antenna formed from a wire having a diameter greater than or equal to 60 μm and less than or equal to 65 μm.

In some embodiments, the antenna 215 may be formed from a different number of windings of a conductive material than the number of windings from which antenna 216 is formed. For instance, antenna 215 may be a low frequency antenna formed from a smaller number of windings than a high frequency antenna 216.

According to some embodiments, the winding directions of the antennas 215 and 216 may be arranged to avoid parasitic injections from one of the antennas during its operation into the other antenna. For instance, the winding directions of the antennas 215 and 216 may be arranged so that the antenna 215 is wound in the opposite direction to antenna 216 (e.g., antenna 215 is wound with a winding sense toward antenna 216, and antenna 216 wound with a winding sense toward antenna 215).

In the example of FIG. 2, connections 221 and 222 galvanically connect the integrated circuit 201 to the antennas 215 and 216. In some embodiments, the connections 221 and/or 222 may be formed from a portion of wire that is a part of, or separate from, the antennas 215 or 216. In some embodiments, the connections 221 and/or 222 may be produced by directly coupling the integrated circuit 201 onto the antennas 215 and/or 216 (e.g., pads or other conductive connections of the integrated circuit may be attached to the antenna through soldering, thermocompression bonding, and/or some other technique).

According to some embodiments, the dual frequency RFID device 200 may be arranged within a suitable housing that includes the antennas 215 and 216, and the integrated circuit 201. For instance, the housing may be a capsule comprising, or formed from, glass or some other dielectric.

In the example of FIG. 2, a distance between the antenna 215 and antenna 216 along the length of the core 202 (labeled 225 in FIG. 2) may be larger than a width of the integrated circuit along the same direction (labeled 226 in FIG. 2). In some embodiments, the ratio between the distance 225 and the distance 226 is greater than or equal to 1.2, 1.3, 1.4, 1.5, 1.6 or 1.7. In some embodiments, the ratio between the distance 225 and the distance 226 is less than or equal to 2, 1.9, 1.8, 1.7, 1.6, 1.5, 1.4, or 1.3. Any suitable combinations of the above-referenced ranges are also possible (e.g., the ratio between the distance 225 and the distance 226 is greater than or equal to 1.4 and less than or equal to 1.6, etc.). Providing a suitably large distance between the antenna 215 and antenna 216 may limit interference between the two antennas.

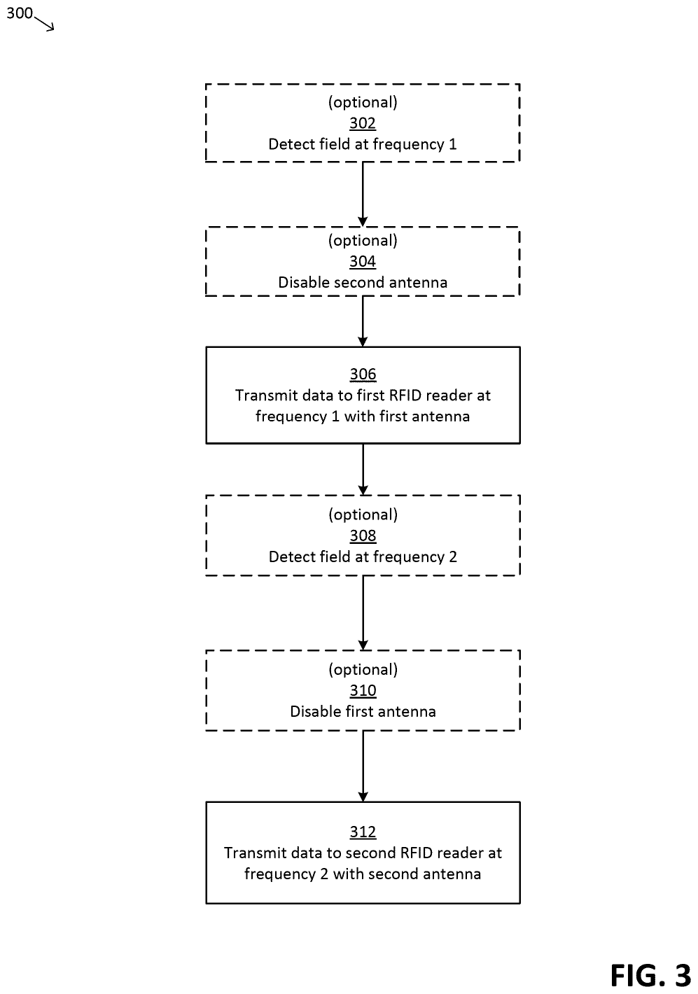

FIG. 3 is a flowchart of a method of operating a dual frequency RFID device, according to some embodiments. Method 300 may be performed by devices such as dual frequency RFID device 101 shown in FIG. 1 or dual frequency RFID device 200 shown in FIG. 2, which are described above.

According to some embodiments, Method 300 includes an optional act 302 in which the dual frequency RFID device detects an electromagnetic field at a first frequency (“frequency 1”). As described above in relation to FIG. 1, a controller of a dual frequency RFID device may be configured to detect the presence of such a field (e.g., by detecting a signal via an antenna configured to operate at that frequency, or otherwise) and to take action in response. In the example of FIG. 3, in act 304 the dual frequency RFID device optionally disables a second antenna to limit interference between an antenna that will receive data at the first frequency and the second antenna, which operates at a different frequency. For example, when detecting a LF signal in act 302, the dual frequency RFID device may disable a HF antenna.

In act 306, the dual frequency RFID device transmits data to a first RFID reader (e.g. a LF RFID reader). The data transmitted may for instance include a unique identifier that uniquely identifies the dual frequency RFID device performing method 300. Various techniques for transmitting such data is described above.

In optional act 308, the dual frequency RFID device detects an electromagnetic field at a second frequency (“frequency 2”). As described above in relation to FIG. 1, a controller of a dual frequency RFID device may be configured to detect the presence of such a field (e.g., by detecting a signal via an antenna configured to operate at that frequency, or otherwise) and to take action in response. In the example of FIG. 3, in act 310 the dual frequency RFID device optionally disables the first antenna to limit interference between the second antenna that will receive data at the second frequency and the first antenna, which operates at a different frequency. For example, when detecting a HF signal in act 308, the dual frequency RFID device may disable a LF antenna.

In act 312, the dual frequency RFID device transmits data to a second RFID reader (e.g. a HF RFID reader, such as an NFC device). The data transmitted may for instance include a unique identifier that uniquely identifies the dual frequency RFID device performing method 300. Various techniques for transmitting such data are described above.

According to some embodiments, Method 300 may be performed in a variety of use cases, including but not limited to identify an animal (e.g., attached to, or surgically implanted with, the dual frequency RFID device performing method 300), to identify an individual for access control or other reasons, or to identify an object (e.g., comprising or otherwise coupled to the dual frequency RFID device performing method 300). Objects may include industrial storage units or other inventory, pharmaceuticals, etc.

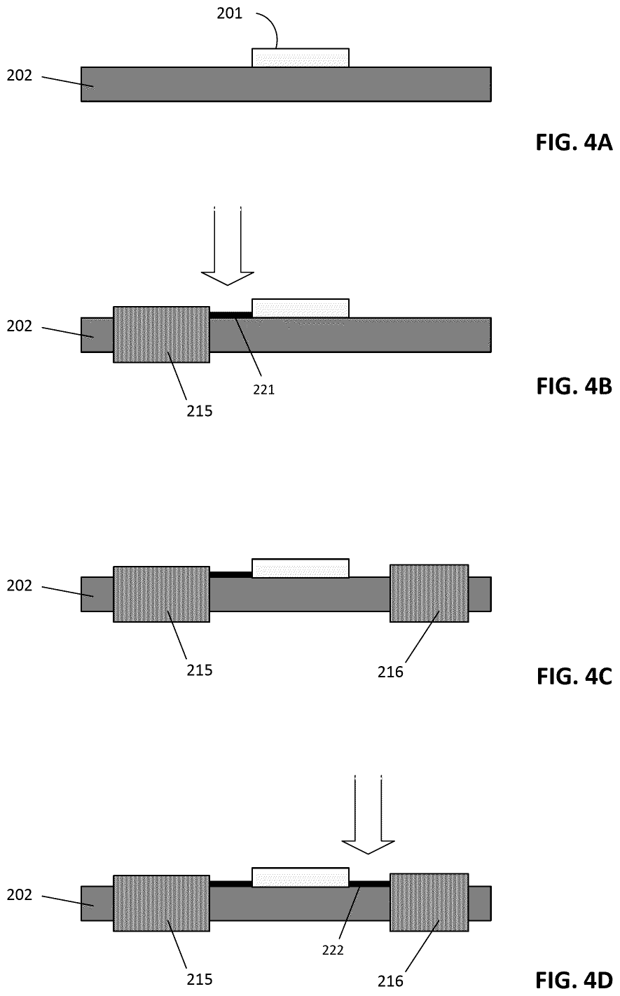

FIGS. 4A-4D depict a first process of fabricating the dual frequency RFID device 200 shown in FIG. 2, according to some embodiments. In the example of FIGS. 4A-4D, initially the core 202 is obtained and the integrated circuit 201 placed on the core. In some embodiments, the integrated circuit 201 may be adhesively attached to the core (e.g., with glue or a pressure-sensitive adhesive layer). In some embodiments, such an adhesive may be a non-conductive adhesive.

In the example of FIG. 4B, the antenna 215 is formed by winding a conductor around the core 202 (e.g., by moving a conductor around the core, or by rotating the core while holding the conductor in an appropriate location). In addition, a galvanic connection 221 is formed between the antenna 215 and integrated circuit 201. As described above, such a connection may be formed from a portion of wire that is a part of, or separate from, the antenna 215. In some embodiments, the integrated circuit is directly connected to the antenna 215 through thermocompression bonding. For instance, bumps or pads on the underside of the integrated circuit 201 may be bonded to the antenna 215 through thermocompression bonding (e.g., using a thermode, for example).

In the example of FIG. 4C, the antenna 216 is formed by winding a conductor around the core 202 (e.g., by moving a conductor around the core, or by rotating the core while holding the conductor in an appropriate location). In some embodiments, the partially-fabricated device as shown in FIG. 4B may be rotated 180° so that the same external device or system that wound antenna 215 also winds antenna 216. In the example of FIG. 4C, however, the device is shown without such a rotation.

In the example of FIG. 4D, a galvanic connection 222 is formed between the antenna 216 and integrated circuit 201. As described above, such a connection may be formed from a portion of wire that is a part of, or separate from, the antenna 216. In some embodiments, the integrated circuit is directly connected to the antenna 216 through thermocompression bonding. For instance, bumps or pads on the underside of the integrated circuit 201 may be bonded to the antenna 216 through thermocompression bonding (e.g., using a thermode, for example).

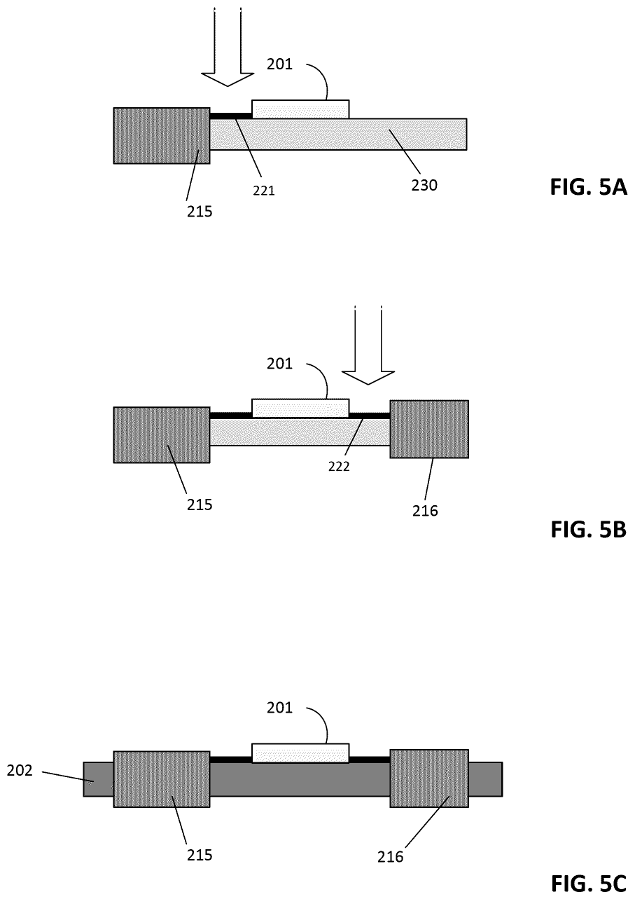

FIGS. 5A-5C depict a second process of fabricating the dual frequency RFID device 200 shown in FIG. 2, according to some embodiments. As an alternative to the process of FIGS. 4A-4D, the dual frequency RFID device 200 may instead be fabricated by forming the antennas with their connections to the integrated circuit before inserting the core 202.

As shown in FIG. 5A, the antenna 215 may be formed and connected to integrated circuit 201 via connection 221 on a substrate or other support 230, via any of the techniques described above in relation to forming antenna 215 or forming connection 221. Similarly, the antenna 216 may be formed and connected to integrated circuit 201 via connection 222 on the substrate or other support 230, via any of the techniques described above in relation to forming antenna 216 or forming connection 222.

Subsequently, the substrate or other support 230 may be removed from the interior of the antennas 215 and 216, and the core 202 inserted into the interior of the antennas 215 and 216. In some embodiments, the integrated circuit may be adhesively attached to the core via any of the techniques described above in relation to FIG. 4A.

Having thus described several aspects of at least one embodiment of the disclosed systems and methods, it is to be appreciated that various alterations, modifications, and improvements will readily occur to those skilled in the art. For instance, aspects of the techniques described herein may be combined in any of the following ways:

According to some aspects, the techniques described herein relate to a device including: a first antenna configured to transmit at a first frequency; a second antenna configured to transmit at second frequency, different from the first frequency; a non-transitory computer readable storage medium storing first data; and a controller coupled to the first antenna and to the second antenna and configured to: transmit the first data stored in the non-transitory computer readable storage medium via the first antenna at the first frequency; and transmit the first data stored in the non-transitory computer readable storage medium via the second antenna at the second frequency.

According to some aspects, the techniques described herein relate to a device, wherein the controller is further configured to: detect a field at the first frequency and to, in response, transmit the first data via the first antenna; and detect a field at the second frequency and to, in response, transmit the first data via the second antenna.

According to some aspects, the techniques described herein relate to a device, wherein the controller is further configured to disable the second antenna in response to detecting the field at the first frequency, and to disable the first antenna in response to detecting the field at the second frequency.

According to some aspects, the techniques described herein relate to a device, wherein the controller is further configured to, in response to detecting both the field at the first frequency and the field at the second frequency, disable the second antenna.

According to some aspects, the techniques described herein relate to a device, wherein the first frequency is between 100 kHz and 150 kHz and wherein the second frequency is between 13.5 MHz and 13.6 MHz.

According to some aspects, the techniques described herein relate to a device, wherein the first antenna is a low frequency (LF) antenna and wherein the second antenna is a near field communication (NFC) antenna.

According to some aspects, the techniques described herein relate to a device, further including a ferrite core, wherein the first antenna includes a first plurality of conductive windings around the ferrite core, and wherein the second antenna includes a second plurality of conductive windings around the ferrite core.

According to some aspects, the techniques described herein relate to a device, wherein the controller and the non-transitory computer readable storage medium are arranged on the ferrite core between the first plurality of conductive windings and the second plurality of conductive windings.

According to some aspects, the techniques described herein relate to a device, wherein the first plurality of conductive windings are wound in an opposing direction to the second plurality of conductive windings.

According to some aspects, the techniques described herein relate to a device, wherein the device is a passive radio-frequency identification (RFID) tag.

According to some aspects, the techniques described herein relate to a device, further including a glass capsule in which the first antenna, second antenna and controller are arranged.

According to some aspects, the techniques described herein relate to a device, wherein the controller is coupled to the first antenna and to the second antenna via thermocompression bonding.

According to some aspects, the techniques described herein relate to a device, wherein the controller and the non-transitory computer readable storage medium are arranged on a single die.

According to some aspects, the techniques described herein relate to a device, wherein the non-transitory computer readable storage medium is an eFuse memory.

According to some aspects, the techniques described herein relate to a system including: a passive radio-frequency identification (RFID) tag including: a first antenna configured to transmit at a first frequency; a second antenna configured to transmit at second frequency, different from the first frequency; a non-transitory computer readable storage medium storing first data; and a controller coupled to the first antenna and to the second antenna and configured to: transmit the first data stored in the non-transitory computer readable storage medium via the first antenna at the first frequency; and transmit the first data stored in the non-transitory computer readable storage medium via the second antenna at the second frequency; a first RFID reader configured to communicate with the first antenna of the RFID tag at the first frequency and thereby receive the first data stored in the non-transitory computer readable storage medium; and a second RFID reader configured to communicate with the second antenna of the RFID tag at the second frequency and thereby receive the first data stored in the non-transitory computer readable storage medium.

According to some aspects, the techniques described herein relate to a system, wherein the first frequency is between 100 kHz and 150 kHz and wherein the second frequency is between 13.5 MHz and 13.6 MHz.

According to some aspects, the techniques described herein relate to a system, wherein the first antenna is a low frequency (LF) antenna wherein the second antenna is a near field communication (NFC) antenna, wherein the first RFID reader is an LF reader and wherein the second RFID reader is an NFC reader.

According to some aspects, the techniques described herein relate to a system, wherein the RFID tag further includes a ferrite core, wherein the first antenna includes a first plurality of conductive windings around the ferrite core, and wherein the second antenna includes a second plurality of conductive windings around the ferrite core.

According to some aspects, the techniques described herein relate to a system, wherein the controller is arranged on the ferrite core between the first plurality of conductive windings and the second plurality of conductive windings.

According to some aspects, the techniques described herein relate to a system, wherein the first plurality of conductive windings are wound in an opposing direction to the second plurality of conductive windings.

According to some aspects, the techniques described herein relate to a system, wherein the RFID tag further includes a glass capsule in which the first antenna, second antenna and controller are arranged.

According to some aspects, the techniques described herein relate to a system, wherein the controller and the non-transitory computer readable storage medium are arranged on a single die.

According to some aspects, the techniques described herein relate to a system, wherein the non-transitory computer readable storage medium is an eFuse memory.

According to some aspects, the techniques described herein relate to a method including: transmitting, by a controller, first data to a first radio-frequency identification (RFID) reader at a first communication frequency via a first antenna, wherein the first data is stored in a non-transitory computer readable storage medium; and transmitting, by the controller, the first data stored in the non-transitory computer readable storage medium to a second RFID reader at a second communication frequency, different from the first frequency, via a second antenna.

According to some aspects, the techniques described herein relate to a method, further including detecting a field at the first frequency, and wherein said transmitting the first data to the first RFID reader is in response to detecting the field at the first frequency.

According to some aspects, the techniques described herein relate to a method, further including detecting a field at the second frequency, and disabling the first antenna in response.

According to some aspects, the techniques described herein relate to a method, wherein the first antenna includes a first plurality of conductive windings around a ferrite core, and wherein the second antenna includes a second plurality of conductive windings around the ferrite core.

According to some aspects, the techniques described herein relate to a method, wherein the controller and the non-transitory computer readable storage medium are arranged on the ferrite core between the first plurality of conductive windings and the second plurality of conductive windings.

According to some aspects, the techniques described herein relate to a method including: winding a first plurality of conductive turns to form a first antenna; winding a second plurality of conductive turns to form a second antenna; arranging an integrated circuit including a controller and a non-transitory computer readable storage medium between the first antenna and second antenna; and galvanically connecting the integrated circuit to the first antenna and to the second antenna.

According to some aspects, the techniques described herein relate to a method, wherein winding the first plurality of conductive turns includes winding the first plurality of conductive turns around a ferrite core, wherein winding the second plurality of conductive turns includes winding the second plurality of conductive turns around the ferrite core, and wherein the integrated circuit is arranged on the ferrite core.

According to some aspects, the techniques described herein relate to a method, further including inserting a ferrite core through the first plurality of conductive turns and through the second plurality of conductive turns.

According to some aspects, the techniques described herein relate to a method, wherein the first antenna is configured to transmit at a frequency between 100 kHz and 150 kHz and wherein the second antenna is configured to transmit at a frequency between 13.5 MHz and 13.6 MHz.

According to some aspects, the techniques described herein relate to a method, wherein first plurality of conductive turns are wound in a first winding direction, and wherein the second plurality of conductive turns are wound in a second winding direction, opposite to the first winding direction.

According to some aspects, the techniques described herein relate to a method, further including arranging the ferrite core, the first antenna, the second antenna and the integrated circuit in a glass capsule.

According to some aspects, the techniques described herein relate to a method, further including arranging the ferrite core, the first antenna, the second antenna and the integrated circuit in a glass capsule.

Such alterations, modifications, and improvements are intended to be part of this disclosure, and are intended to be within the spirit and scope of the instant disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, a controller of a dual frequency RFID device may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A device comprising:
a first antenna configured to communicate at a first frequency;
a second antenna configured to communicate at second frequency, the second frequency being different from the first frequency, the second frequency being separated to the first frequency by a factor of 100;
a memory storing first data; and
a controller coupled to the first antenna and coupled to the second antenna, the controller configured to:
detect an electromagnetic field at at least one of the first frequency or the second frequency; and
transmit the first data stored in the memory based on the detection, the transmission comprising:
transmitting the first data stored in the memory via the first antenna at the first frequency when the electromagnetic field is detected at the first frequency and when the electromagnetic field is detected at the first frequency and the second frequency; and
transmit the first data stored in the memory via the second antenna at the second frequency when the electromagnetic field is detected at the second frequency

2. (canceled)

3. The device of claim 1, wherein the controller is further configured to disable the second antenna in response to detecting the electromagnetic field at the first frequency, and to disable the first antenna in response to detecting the electromagnetic field at the second frequency.

4. The device of claim 1, wherein the controller is further configured to, in response to detecting the electromagnetic field at the first frequency and the second frequency, disable the second antenna.

5. The device of claim 1, wherein the first frequency is between 100 kHz and 150 kHz and wherein the second frequency is between 13.5 MHz and 13.6 MHz.

6. The device of claim 1, further comprising a ferrite core, the first antenna comprising a first plurality of conductive windings around the ferrite core, and the second antenna comprising a second plurality of conductive windings around the ferrite core.

7. The device of claim 6, further comprising the first plurality of conductive windings being wound in an opposing direction to the second plurality of conductive windings.

8. The device of claim 1, further comprising the first data from the first antenna and second antenna being communicated to a cloud.

9. A method comprising:
detecting, by a controller, an electromagnetic field at at least one of a first frequency or a second frequency, the first frequency and the second frequency being different frequencies, and being frequencies separated by a factor of 100; and
transmitting, by the controller, data to a first radio-frequency identification (RFID) or a second RFID reader based on the detection, the transmitting comprising:
transmitting, by the controller, the data to the first RFID reader at the first frequency via a first antenna associated with the controller when the electromagnetic field is detected at the first frequency and when the electromagnetic field is detected at the first frequency and the second frequency; and
transmitting, by the controller, to the second RFID reader at the second frequency via a second antenna associated with the controller when the electromagnetic field is detected at the second frequency.

10. (canceled)

11. The method of claim 9, further comprising detecting the electromagnetic field at the second frequency, and disabling the first antenna in response.

12. The method of claim 9, wherein the first antenna comprises a first plurality of conductive windings around a ferrite core, and wherein the second antenna comprises a second plurality of conductive windings around the ferrite core.

13. The method of claim 12, further comprising the controller being arranged on the ferrite core between the first plurality of conductive windings and the second plurality of conductive windings.

14. A method comprising:
winding a first plurality of conductive turns to form a first antenna;
winding a second plurality of conductive turns to form a second antenna;
arranging an integrated circuit comprising a controller and a non-transitory computer readable storage medium between the first antenna and second antenna; and
galvanically connecting the integrated circuit to the first antenna and to the second antenna.

15. The method of claim 14, wherein winding the first plurality of conductive turns comprises winding the first plurality of conductive turns around a ferrite core, wherein winding the second plurality of conductive turns comprises winding the second plurality of conductive turns around the ferrite core, and wherein the integrated circuit is arranged on the ferrite core.

16. The method of claim 14, further comprising inserting a ferrite core through the first plurality of conductive turns and through the second plurality of conductive turns.

17. The method of claim 14, wherein the first antenna is configured to transmit at a frequency between 100 kHz and 150 kHz and wherein the second antenna is configured to transmit at a frequency between 13.5 MHz and 13.6 MHz.

18. The method of claim 14, wherein first plurality of conductive turns is wound in a first winding direction, and wherein the second plurality of conductive turns are wound in a second winding direction, opposite to the first winding direction.

19. The method of claim 15, further comprising arranging the ferrite core, the first antenna, the second antenna and the integrated circuit in a dielectric capsule.

20. The method of claim 16, further comprising arranging the ferrite core, the first antenna, the second antenna and the integrated circuit in a dielectric capsule.
